(19) United States
(12) Patent Application Publication
(10) Pub. No.: US 2025/0159573 A1
(43) Pub. Date: May 15, 2025

(54) WIRELESS COMMUNICATIONS APPARATUS AND METHODS

(71) Applicant: Sony Group Corporation, Tokyo (JP)

(72) Inventors: Hideji WAKABAYASHI, Basingstoke (GB); Vivek SHARMA, Basingstoke (GB); Yuxin WEI, Basingstoke (GB); Yassin Aden AWAD, Basingstoke (GB); Samuel Asangbeng ATUNGSIRI, Basingstoke (GB)

(73) Assignee: Sony Group Corporation, Tokyo (JP)

(21) Appl. No.: 19/021,267

(22) Filed: Jan. 15, 2025

Related U.S. Application Data
(63) Continuation of application No. 17/632,507, filed on Feb. 3, 2022.

(30) Foreign Application Priority Data
Aug. 23, 2019 (EP) 19193488.4

(51) Int. Cl. H04W 36/00; H04W 36/08

(52) U.S. Cl. CPC H04W 36/0094; H04W 36/0058; H04W 36/08

(57) ABSTRACT

A method of configuring a communications device in a wireless communications network comprising a non-terrestrial network part, the method comprising: establishing a connection in a serving cell between the communications device and the wireless communications network for transmitting data to and receiving data from the communications device, identifying a candidate cell for a handover of the communications device, determining that one or both of the serving cell and the candidate cell is provided by a non-terrestrial network part of the wireless communications network, based on the determining that one or both of the serving cell and the candidate cell is provided by a non-terrestrial network part of the wireless communications network, determining as a measurement window a time period during which the communications device can receive measurement signals transmitted in the candidate cell, and configuring the communications device to measure the measurement signals received within the measurement window.

### CROSS-REFERENCE TO RELATED APPLICATIONS

The present application is Continuation of U.S. application Ser. No. 17/632,507, filed on Feb. 3, 2022, which is based on PCT/EP2020/073265 filed on Aug. 19, 2020, and claims priority to EP 19193488.4 filed on Aug. 23, 2019, the entire contents of each are incorporated herein by reference.

### BACKGROUND

### Field

The present disclosure relates to wireless communications apparatus and methods for configuring measurements by a communications device of a cell of a wireless communications network provided by a non-terrestrial network part.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the third generation partnership project (3GPP) defined UMTS and Long Term Evolution (LTE) architectures, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will therefore be expected to routinely and efficiently support communications with a wider range of devices associated with a wider range of data traffic profiles and types than current systems are optimised to support. For example it is expected that future wireless communications networks will efficiently support communications with devices including reduced complexity devices, machine type communication (MTC) devices, high resolution video displays, virtual reality headsets and so on. Some of these different types of devices may be deployed in very large numbers, for example low complexity devices for supporting the “Internet of Things”, and may typically be associated with the transmission of relatively small amounts of data with relatively high latency tolerance.

In view of this there is expected to be a desire for future wireless communications networks, for example those which may be referred to as 5G or new radio (NR) system/new radio access technology (RAT) systems [3], as well as future iterations/releases of existing systems, to efficiently support connectivity for a wide range of devices associated with different applications and different characteristic data traffic profiles. There is similarly expected to be a desire for such connectivity to be available over a wide geographic area.

One example area of current interest in this regard includes so-called “non-terrestrial networks”, or NTN for short. The 3GPP has proposed in Release 15 of the 3GPP specifications to develop technologies for providing coverage by means of one or more antennas mounted on an airborne or space-borne vehicle [1][5].

Non-terrestrial networks may provide service in areas that cannot be covered by terrestrial cellular networks (i.e. those where coverage is provided by means of land-based antennas), such as isolated or remote areas, on board aircraft or vessels) or may provide enhanced service in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

The use of different types of network infrastructure equipment and requirements for coverage enhancement give rise to new challenges for efficiently handling communications in wireless telecommunications systems that need to be addressed.

Some challenges associated with measurements of NTN cells are identified in [6].

### SUMMARY

The present disclosure can help address or mitigate at least some of the issues discussed above.

According to the present technique there is provided a method of configuring a communications device in a serving cell of a wireless communications network comprising a non-terrestrial network part, the method comprising: establishing a connection in the serving cell between the communications device and the wireless communications network for transmitting data to and receiving data from the communications device, identifying a candidate cell for a handover of the communications device, determining that one or both of the serving cell and the candidate cell is provided by a non-terrestrial network part of the wireless communications network, based on the determining that one or both of the serving cell and the candidate cell is provided by a non-terrestrial network part of the wireless communications network, determining as a measurement window a time period during which the communications device can receive measurement signals transmitted in the candidate cell, and configuring the communications device to measure the measurement signals received within the measurement window.

Embodiments of the present technique can provide an arrangement which improves the a continuity of service for a communications device which is within a coverage region of a cell provided by a non-terrestrial part, even if the coverage region of the cell may be moving with respect to the surface of the Earth and/or with respect to the communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 illustrates 5G/NR measurement gaps configured in accordance with conventional techniques;

FIG. 4 schematically represents some example aspects of a wireless telecommunication system which may be configured to operate in accordance with embodiments of the present disclosure;

FIG. 5 is a timing diagram showing misalignment of measurement windows with received measurement signals;

FIG. 6 is a timing diagram showing a configuration of measurement windows in accordance with embodiments of the present technique;

FIG. 7 illustrates a measurement configuration in accordance with some embodiments of the present technique;

FIG. 8 illustrates an example of determining a start time for measurements based on an indicated timing advance in accordance with embodiments of the present technique;

FIG. 9 illustrates a process for determining measurement parameters in accordance with embodiments of the present disclosure; and

FIG. 10 illustrates a message sequence chart and process flow diagram for a process of performing measurements of candidate cells in accordance with embodiments of the present disclosure.

### DETAILED DESCRIPTION OF THE EMBODIMENTS

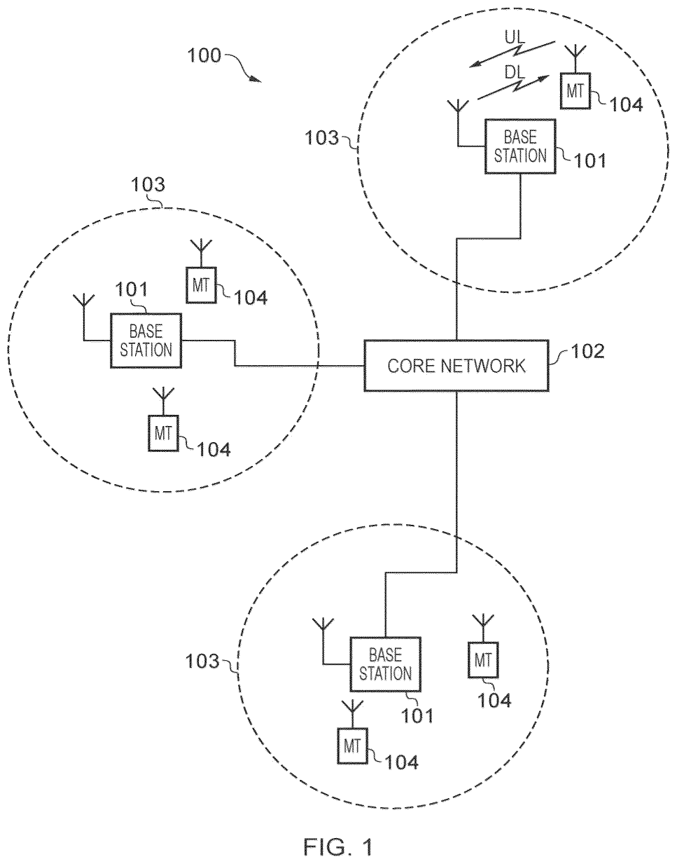

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs (eNB), g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

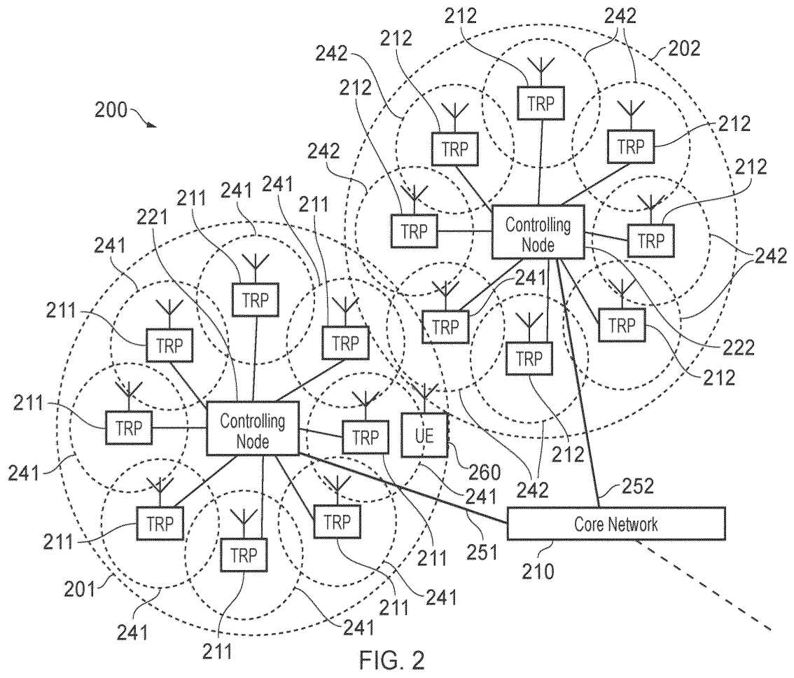

FIG. 2 is a schematic diagram illustrating a network architecture for a new Radio Access Technology (RAT) wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communications cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

In wireless telecommunications networks, such as LTE type or 5G type networks, there are different Radio Resource Control (RRC) modes for communications devices. For example, it is common to support an RRC connected mode (RRC_CONNECTED). A communications device in the RRC connected mode is able to transmit uplink data and receive downlink data.

In the RRC Connected mode, mobility may be network-controlled; that is, a handover may be initiated by an infrastructure equipment of the network. The handover may be conventionally initiated in response to, for example, measurement reports transmitted by the communications device, which may indicate the result of measurements of downlink signals transmitted by the network in both the serving cell and one or more neighbour (candidate) cells.

To support these measurements, infrastructure equipment may transmit reference signals in each cell continuously or periodically according to a pre-determined transmission schedule on a frequency (or in a band, centred on a frequency) which is configured by the wireless communications network operator.

In order to measure the downlink signals of a candidate cell, the communications device may need to retune receiver circuitry in order to detect and measure the downlink signals. There may be a period, therefore, when the communications device is unable to receive signals transmitted in its current (serving) cell.

Conventionally, the infrastructure equipment associated with the serving cell may configure the communications device with measurement gaps during which the infrastructure equipment will refrain from scheduling uplink or downlink communications with the communications device, and during which the communications device can perform measurements of the downlink signals of the candidate cell.

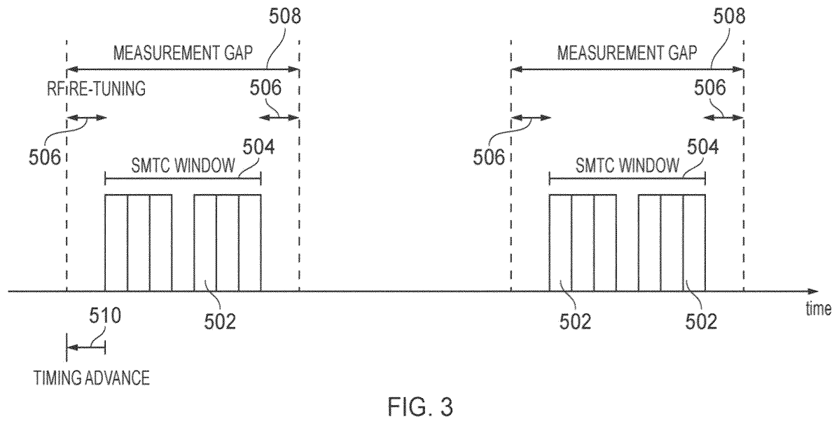

FIG. 3 illustrates 5G/NR measurement gaps configured in accordance with conventional techniques.

In 5G/NR, configured measurement gaps 508 may be based on a known schedule of transmission of downlink signals in the candidate cell which are particularly suitable for measurements. Downlink signals suitable for measurements are generally referred to herein as measurement signals. These measurement signals may comprise in 5G/NR a synchronization signal (SS) and a physical broadcast channel (PBCH), which are transmitted in sequences of SS/PBCH Blocks (SSB) 502, the sequences being periodically transmitted. In LTE, the measurement signals may comprise cell-specific reference signals (CRS).

A measurement gap may comprise a measurement window 504 corresponding to the time period during which the measurement signals are to be received and measured, and two radio frequency (RF) retuning periods 506, one preceding and one following the measurement window 504. The start time of the measurement gap 508 may be defined by the start time of the measurement window 504 and a timing advance 510. The timing advance 510 may correspond to the duration of the RF re-tuning period 506 which precedes the measurement window 504.

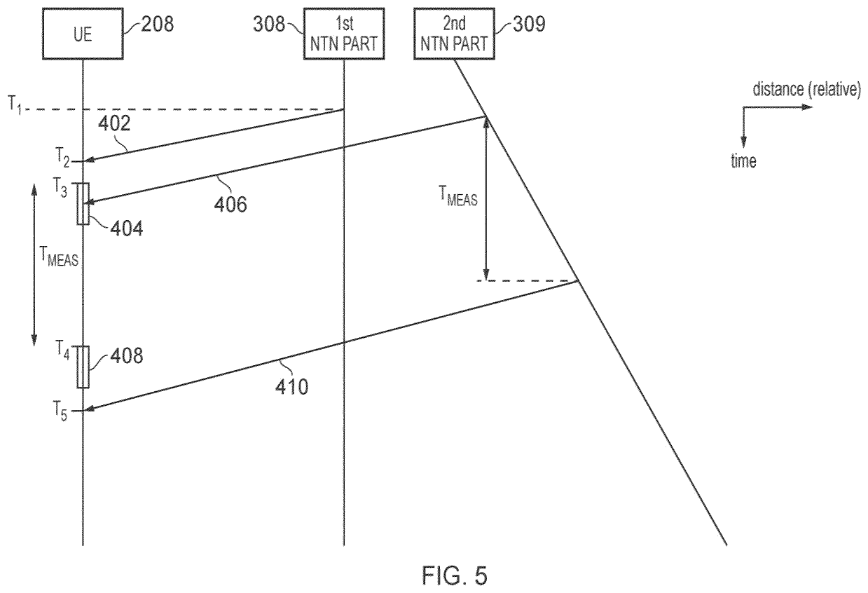

In 5G/NR, the measurement window 504 may be referred to as an SSB-based radio resource management (RRM) timing configuration (SMTC) window. In the example of FIG. 5, the measurement signals which the communications device is to measure (SSBs 502) are transmitted in a sequence having a measurement signal sequence duration, each sequence being transmitted periodically, according to a measurement signal schedule. In the example of FIG. 5, the SMTC window is set to be equal to the measurement signal sequence duration, and the periodicity of the SMTC windows is set to be equal to the measurement signal sequence periodicity. Accordingly, the communications device is configured to receive and measure all measurement signals.

In some examples, the periodicity of the SMTC windows may be a multiple of the measurement signal sequent periodicity so that some measurement signals are not within an SMTC window and are thus not measured.

Because the measurement gap 508 corresponds to a period when the serving infrastructure equipment refrains from scheduling uplink or downlink transmissions for the communications device, it is preferable to minimise the total length of the measurement gap.

In some examples, each RF retuning period 506 may be 0.5 ms. In some examples, the SMTC window 504 may have a duration corresponding to the duration of an SSB sequence. In the example of FIG. 3, measurement gaps are configured for each SSB sequence, however it will be appreciated that the periodicity of the measurement gaps may be different from (e.g. a multiple of) the periodicity of the SSB sequences.

Details of conventional configuration parameters associated with measurements of neighbour cell measurement signals can be found in [4], the contents of which are incorporated herein by reference.

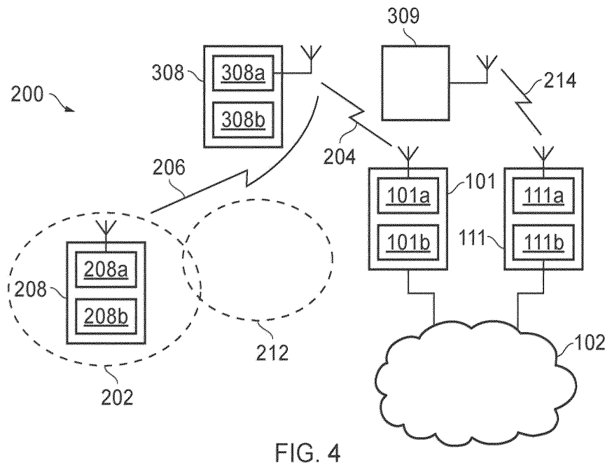

FIG. 4 schematically shows a wireless telecommunications system 200 according to example embodiments of the present disclosure. The wireless telecommunications system 200 in this example is based broadly around an LTE-type or 5G-type architecture. Many aspects of the operation of the wireless telecommunications system/network 200 are known and understood and are not described here in detail in the interest of brevity. Operational aspects of the wireless telecommunications system 200 which are not specifically described herein may be implemented in accordance with any known techniques, for example according to the current LTE-standards or the proposed 5G standards.

The wireless telecommunications system 200 comprises a core network part 102 (which may be a 4G core network or a 5G core network) coupled to a radio network part. The radio network part comprises a base station (g-node B) 101 coupled to a non-terrestrial network part 308. The non-terrestrial network part 308 may be an example of infrastructure equipment.

The non-terrestrial network part 308 may be mounted on a satellite vehicle or on an airborne vehicle.

The non-terrestrial network part 308 is further coupled to a communications device 208, located within a cell 202, by means of a wireless access interface provided by a wireless communications link 206. For example, the cell 202 may correspond to the coverage area of a spot beam generated by the non-terrestrial network part 308.

The boundary of the cell 202 may depend on an altitude of the non-terrestrial network part 308 and a configuration of one or more antennas of the non-terrestrial network part 308 by which the non-terrestrial network part 308 transmits and receives signals on the wireless access interface.

The non-terrestrial network part 308 may be a satellite in an orbit with respect to the Earth, or may be mounted on such a satellite. For example, the satellite may be in a geo-stationary earth orbit such that the non-terrestrial network part 308 does not move substantially with respect to a fixed point on the Earth's surface. The geo-stationary earth orbit may be approximately 36,000 km above the Earth's equator. Alternatively, the satellite may be in an non-geostationary orbit, so that the non-terrestrial network part 308 moves with respect to a fixed point on the Earth's surface.

The non-terrestrial network part 308 may be an airborne vehicle such as an aircraft, or may be mounted on such a vehicle. The airborne vehicle (and hence the non-terrestrial network part 308) may be stationary with respect to the surface of the Earth (e.g. the non-terrestrial network part 308 may be attached to, or form part of a stationary balloon structure, the balloon structure tethered to a fixed point on the surface of the earth) or may move with respect to the surface of the Earth.

In FIG. 4, the base station 101 is shown as ground-based, and coupled to the non-terrestrial network part 308 by means of a wireless communications link 204. The non-terrestrial network part 308 receives signals representing downlink data transmitted by the base station 101 on the wireless communications link 204 and, based on the received signals, transmits signals representing the downlink data via the wireless communications link 206 providing the wireless access interface for the communications device 208. Similarly, the non-terrestrial network part 308 receives signals representing uplink data transmitted by the communications device 208 via the wireless access interface comprising the wireless communications link 206 and transmits signals representing the uplink data to the base station 101 on the wireless communications link 204.

In some embodiments, the wireless communications links 204, 206 operate at a same frequency; in some embodiments, the wireless communications links 204, 206 operate at different frequencies.

The extent to which the non-terrestrial network part 308 processes the received signals may depend upon a processing capability of the non-terrestrial network part 308. For example, the non-terrestrial network part 308 may receive signals representing the downlink data on the wireless communication link 204, amplify them and (if needed) re-modulate onto an appropriate carrier frequency for onwards transmission on the wireless access interface provided by the wireless communications link 206.

Alternatively, the non-terrestrial network part 308 may be configured to decode the signals representing the downlink data received on the wireless communication link 204 into un-encoded downlink data, re-encode the downlink data and modulate the encoded downlink data onto the appropriate carrier frequency for onwards transmission on the wireless access interface provided by the wireless communications link 206.

In some examples, the non-terrestrial network part 308 may be configured to perform some of the functionality conventionally carried out by the base station 101. In particular, latency-sensitive functionality (such as acknowledging a receipt of the uplink data, or responding to a random access request) may be performed by the non-terrestrial network part 308 instead of by the base station 101.

In some embodiments, the base station 101 may be co-located with the non-terrestrial network part 308; for example, both may be mounted on the same satellite vehicle or airborne vehicle, and there may be a physical (e.g. wired, or fibre optic) connection on board the satellite vehicle or airborne vehicle, providing the coupling between the base station 101 and the non-terrestrial network part 308. In some embodiments, a wireless communications link between the base station 101 and a ground station (not shown) may provide connectivity between the base station 101 and the core network part 102.

The communications device 208 shown in FIG. 4 may broadly correspond to the terminal device 104 of FIG. 1 or the terminal device 260 of FIG. 2. Additionally or alternatively, the communications device 208 may be configured to act as a relay node. That is, it may provide connectivity via a wireless access interface to one or more terminal devices, not shown in FIG. 4. The wireless access interface provided by the communications device 208 for the purposes of providing service and connectivity to terminal devices may comply substantially with the standards for a wireless access interface generated by a base station in accordance with standards, such as the LTE standard or a 5G standard. Data may thus be transmitted by a terminal device to the communications device 208 and by the communications device 208 to the terminal device in accordance with conventional techniques for the transmission of data to a conventional base station or a conventional relay node.

It will be apparent that many scenarios can be envisaged in which the combination of the communications device 208 and the non-terrestrial network part 308 can provide enhanced service to end users. For example, the communications device 208 may be mounted on a passenger vehicle such as a bus or train which travels through rural areas where coverage by terrestrial base stations may be limited. Terminal devices on the vehicle may obtain service via the communications device 208 acting as a relay, which is coupled to the non-terrestrial network part 308.

In addition, FIG. 4 shows a second non-terrestrial network part 309, coupled to a second base station 111 by means of a wireless communications link 214. The second non-terrestrial network part 309 and the second base station 111 may be substantially the same as the first non-terrestrial network part 308 and the first base station 101. A second cell 212 is shown, corresponding to a coverage region provided by the second non-terrestrial network part 309.

There is a need to ensure that connectivity for the communications device 208 with a base station (such as one of the base stations 101, 111) can be maintained while the communications device 208 remains in the connected mode, in spite of movement of the communications device 208, movement of one or more of the non-terrestrial network part 308, 309 (relative to the Earth's surface), or both. For example, where the communications device 208 is currently in the connected mode in the first cell 211, movement of the cell coverage region relative to the communications device 208 may mean that it is desirable to perform a handover of the communications device 208 to the second cell 212 generated by the second non-terrestrial network part 309.

As described above, the decision to change a serving cell of the communications device 208 from the first cell 211 to a candidate cell (such as the second cell 212) may be based on measurements of one or more characteristics of a radio frequency communications channel, such as signal strength measurements or signal quality measurements of measurement signals transmitted in the candidate cell. Conventionally, in the connected mode, measurements occur during configured time windows which are determined based on a schedule of transmissions of measurement signals in the candidate cell.

In a terrestrial communications network, such time windows may be considered to be defined relative to a single reference time frame such as a time frame based on the time of reception at the communications device of certain signals, such as synchronisation signals, transmitted in the serving cell. Deviations or errors due to, for example, different propagation delays for signals transmitted in a serving cell and a candidate cell are negligible and thus have no practical significance. For example, signals transmitted from infrastructure equipment associated with a candidate cell which is 20 km further from the communications device than infrastructure equipment associated with the serving cell will arrive less than 0.1 milliseconds (ms) later than signals simultaneously transmitted in the serving cell. In the context of a measurement gap which may be several milliseconds in duration, this difference is negligible.

However, due to the distances and speeds of non-terrestrial network parts relative to the communications device and/or ground stations, propagation delays (and/or changes thereto) may result in degraded and/or inaccurate measurements.

These disadvantages may be overcome by embodiments of the present technique, according to which a measurement gap configuration is determined based on a candidate cell being provided by means of a non-terrestrial network part.

Embodiments can provide a method of configuring a communications device in a serving cell of a wireless communications network comprising a non-terrestrial network part, the method comprising: establishing a connection in the serving cell between the communications device and the wireless communications network for transmitting data to and receiving data from the communications device, identifying a candidate cell for a handover of the communications device, determining that one or both of the serving cell and the candidate cell is provided by a non-terrestrial network part of the wireless communications network, based on the determining that one or both of the serving cell and the candidate cell is provided by a non-terrestrial network part of the wireless communications network, determining as a measurement window a time period during which the communications device can receive measurement signals transmitted in the candidate cell, and configuring the communications device to measure the measurement signals received within the measurement window.

The measurement gap configuration determined in accordance with embodiments of the present disclosure overcomes disadvantages of the conventional techniques to ensure that accurate measurements can be obtained for measurement signals transmitted in a candidate cell provided by an NTN part.

As shown in FIG. 4, the base station 101 comprises transceiver circuitry 101a (which may also be referred to as a transceiver/transceiver unit) for transmission and reception of wireless signals and processor circuitry 101b (which may also be referred to as a processor/processor unit/controller) configured to control the base station 101 to operate in accordance with embodiments of the present disclosure as described herein. The processor circuitry 101b may comprise various sub-units/sub-circuits for providing desired functionality as explained further herein. These sub-units may be implemented as discrete hardware elements or as appropriately configured functions of the processor circuitry. Thus the processor circuitry 101b may comprise circuitry which is suitably configured/programmed to provide the desired functionality described herein using conventional programming/configuration techniques for equipment in wireless telecommunications systems. The transceiver circuitry 101a and the processor circuitry 101b are schematically shown in FIG. 4 as separate elements for ease of representation. However, it will be appreciated that the functionality of these circuitry elements can be provided in various different ways, for example using one or more suitably programmed programmable computer(s), or one or more suitably configured application-specific integrated circuit(s)/circuitry/chip(s)/chipset(s). It will be appreciated the non-terrestrial base station 101 will in general comprise various other elements associated with its operating functionality.

The non-terrestrial network part 308 comprises transceiver circuitry 308a (which may also be referred to as a transceiver/transceiver unit) for transmission and reception of wireless signals and processor circuitry 308b (which may also be referred to as a processor/processor unit/controller) configured to control the non-terrestrial network part 308. The processor circuitry 308b may comprise various sub-units/sub-circuits for providing functionality as explained further herein. These sub-units may be implemented as discrete hardware elements or as appropriately configured functions of the processor circuitry. Thus the processor circuitry 308b may comprise circuitry which is suitably configured/programmed to provide the desired functionality using conventional programming/configuration techniques for equipment in wireless telecommunications systems. The transceiver circuitry 308a and the processor circuitry 308b are schematically shown in FIG. 4 as separate elements for ease of representation. However, it will be appreciated that the functionality of these circuitry elements can be provided in various different ways, for example using one or more suitably programmed programmable computer(s), or one or more suitably configured application-specific integrated circuit(s)/circuitry/chip(s)/chipset(s). As will be appreciated the non-terrestrial network part 308 will in general comprise various other elements associated with its operating functionality.

The communications device 208 comprises transceiver circuitry 208a (which may also be referred to as a transceiver/transceiver unit) for transmission and reception of wireless signals. The communications device 208 is configured to provide connectivity via the non-terrestrial network part 308. For example, the transceiver circuitry 208b may be adapted in accordance with the nature of the communications channel to the non-terrestrial network part 308, which may be characterized by a high path loss and an absence of multipath.

The communications device 208 further comprises processor circuitry 208b (which may also be referred to as a processor/processor unit/controller) configured to control the communications device 208. The processor circuitry 208b may comprise various sub-units/sub-circuits for providing functionality as explained further herein. These sub-units may be implemented as discrete hardware elements or as appropriately configured functions of the processor circuitry. Thus the processor circuitry 208b may comprise circuitry which is suitably configured/programmed to provide the desired functionality using conventional programming/configuration techniques for equipment in wireless telecommunications systems. The transceiver circuitry 208a and the processor circuitry 208b are schematically shown in FIG. 4 as separate elements for ease of representation. However, it will be appreciated that the functionality of these circuitry elements can be provided in various different ways, for example using one or more suitably programmed programmable computer(s), or one or more suitably configured application-specific integrated circuit(s)/circuitry/chip(s)/chipset(s). As will be appreciated the communications device 208 will in general comprise various other elements associated with its operating functionality.

The processor circuitry 208b, 308b, 101b (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

Each of the communications device 208, first and second base stations 101, 111 and first and second non-terrestrial network parts 308, 309 may be or comprise examples of communications apparatus.

It will be appreciated that in practice the radio network part of the wireless communications network 200 may comprise a plurality of base stations and non-terrestrial network parts serving a larger number of communications devices across various communication cells.

As with a conventional mobile radio network, the communications device 208 is arranged to communicate data to and from the base station (transceiver station) 101. The base station 101 is in turn communicatively connected to one or more core network entities within the core network part 102. The core network part 102 may comprise an enhanced packet core (EPC) network and may comprise a serving gateway, S-GW (not shown for simplicity) which is arranged to perform routing and management of mobile communications services to the communications device 208 in the wireless telecommunications system 200 via the base station 101.

The operation of the various elements of the wireless telecommunications system 200 shown in FIG. 4 may be broadly conventional apart from where modified to provide functionality in accordance with embodiments of the present disclosure as discussed herein.

FIG. 5 is a timing diagram illustrating a problem addressed by the present disclosure.

In FIG. 5, time (not to scale) progresses from top to bottom, while relative distances between entities are represented by the horizontal distance (not to scale) in the figure. In the example of FIG. 5, the first non-terrestrial network part 308 is geo-stationary and providing a serving cell, in which the communications device 208 is in the connected mode. The communications device 208 is stationary with respect to the surface of the Earth and so the distance between the communications device 208 and the first non-terrestrial network part 308 remains unchanged over time.

On the other hand, the second non-terrestrial network part 309 is in an orbit (such as a low earth orbit (LEO)) such that its location relative to the surface of the Earth, and hence relative to the communications device 208 is rapidly changing over time. In particular, the distance of the second non-terrestrial network part 309 from the communications device 208 and from the first non-terrestrial network part 308 is increasing significantly, as indicated by the slope of the corresponding line away from the vertical lines showing the relative position of the communications device 208 and the first non-terrestrial network part 308.

At time T1, a measurement configuration indication 402 is transmitted by the first non-terrestrial network part 308 to the communications device 208 in the serving cell. The measurement configuration indication 402 indicates a periodicity T_{MEAS} and window duration T_{WINDOW} for measurement windows for measuring measurement signals transmitted in the candidate cell 212 generated by the second non-terrestrial network part 309. The measurement configuration indication 402 is received by the communications device 208 at time T2.

T_{MEAS} is set to be a multiple of the periodicity of the transmission of the sequences of measurement signals in the candidate cell 212. In the example of FIG. 5, the multiple is 1, i.e. each successive measurement window is intended to be for receiving and measuring consecutive instances of measurement signal sequences.

Accordingly, the communications device 208 determines that a first measurement window 404 is starting at time T3, and tunes its transceiver circuitry to receive the measurement signals 406 in the candidate cell during the first measurement window 404.

At time T3, the second non-terrestrial network part 309 and the first non-terrestrial network part 308 are relatively closely spaced. Accordingly, the measurement signals 406 transmitted according to the schedule for the candidate cell are received within the first measurement window 404. At the end of the first measurement window 404, the communications device 208 retunes its transceiver circuitry for receiving signals in the serving cell.

Subsequently, the communications device 208 determines that a second measurement window 408 starts at T4=T3+T_{MEAS}. The communications device 208 may measure time based on a reference time frame synchronised with signals received in the serving cell. As such, for example, the reference time frame may drift with respect to an absolute reference time frame if the propagation delay applicable to signals transmitted in the serving cell 211 changes, for example because the communications device 208 moves relative to the first non-terrestrial network part 309, and/or because the first non-terrestrial network part 309 moves relative to its respective ground station.

In the example of FIG. 5, however, the propagation delay for signals in the serving cell does not change. Accordingly, it tunes its transceiver to receive measurement signals transmitted in the candidate cell 212.

However, at this time, the second non-terrestrial network part 309 has moved a significant distance since time T3, such that the propagation delay for signals transmitted from the second non-terrestrial network part 309 is much larger than for signals transmitted by the first non-terrestrial network part 308, and has changed significantly since the measurement configuration indication 402 was received at time T2. As a result, the measurement signals 410 do not arrive at the communications device 208 until T5, which is after the end of the second measurement window 408 and after the time at which the communications device 208 has started to retune its transceiver circuitry to the appropriate frequency for receiving signals in the serving cell 211.

It will be appreciated that similar problems can arise whether or not the first non-terrestrial network part 308 is geostationary, and whether or not the communications device 208 is stationary with respect to the Earth's service. Accordingly, embodiments of the present disclosure are not limited to the scenario illustrated in FIG. 5, but are more generally applicable where the propagation delay of signals (either absolute or relative to a propagation delay of other signals) is such that some or all of the measurement signals which were intended to be received within a particular measurement window configured in a conventional manner are in fact not received within that window.

For example, within the scope of the present disclosure are examples in which both the first non-terrestrial network part 308 and the second non-terrestrial network part 309 are geo-stationary but are separated by a distance such that the propagation delay of signals from the second non-terrestrial network part 309 is significantly different from that of signals from the first non-terrestrial network part 308.

In particular, it will be appreciated that in the example of FIG. 5, the second measurement signals 410 arrived after the end of the second measurement window 408 as a result of the increased propagation delay for signals transmitted by the second non-terrestrial network part 309. In some examples within the scope of the disclosure, the measurement signals may in fact arrive before the start of the measurement window.

In the example of FIG. 5, the propagation delay for the measurement signals 406, 410 is shown as the time from transmission by the second non-terrestrial network part 309 until reception at the communications device 208. According to some embodiments of the present technique, these signals may originate at the base station 111 which is remote from the second non-terrestrial network part 309 (such as located on the Earth's surface at a ground station), and so the propagation delay may include the delay from the transmission by the base station 111 to the reception at the second non-terrestrial network part 309. Additionally or alternatively, transmissions by the first non-terrestrial network part 308 may originate at a ground-based base station. Differences (either constant or changing) in ground station-to-non terrestrial network part propagation delays may further exacerbate the problem illustrated in FIG. 5 and embodiments of the present technique may be applied in such scenarios.

According to some embodiments of the present disclosure, the measurement gap duration T_{WINDOW} is extended in order to accommodate the propagation delay (or change thereof) applicable to the measurement signals transmitted in the candidate cell.

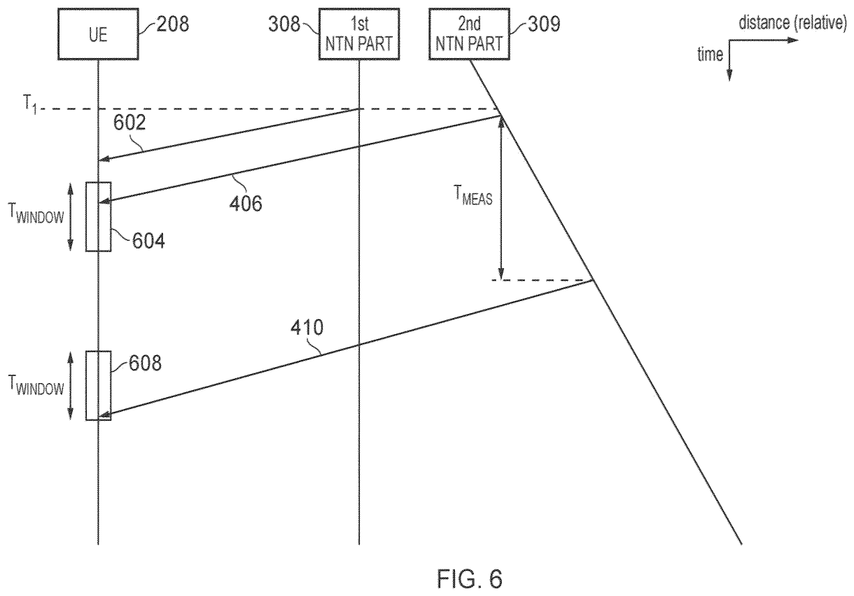

FIG. 6 illustrates a timing diagram showing a configuration of measurement windows in accordance with embodiments of the present technique.

FIG. 6 shows similar elements to those shown in FIG. 5, and like-numbered elements are broadly similar and their description is omitted here for conciseness.

In the example of FIG. 6, to accommodate an additional propagation delay, the duration of the measurement window T_{WINDOW} is set to the duration of the measurement window 504 plus an additional time period to accommodate propagation delays applicable to the measurement signals received by the communications device 208 which are significantly higher or lower, or change significant, or are significantly different with respect to the serving cell signals. In other words, the duration of the measurement window is set to the transmission time (i.e. duration) of the measurement signals to be measured in the window plus an additional amount corresponding to, or based on, the absolute or relative propagation delays applicable to the measurement signals. The differences in propagation delays may arise as a result of motion of one or more non-terrestrial network parts relative to each other or to the communications device, or to their respective ground stations. The differences may be constant over time (e.g. where two non-terrestrial network parts are both in a geo-stationary orbit, but where the signals nevertheless have different propagation delays) or may vary in time.

For example, in the example of FIG. 6 the additional amount may be 2 ms, to accommodate an additional propagation delay corresponding to a distance of up to approximately 600 km; the actual accommodated difference in propagation delay may depend on atmospheric effects such as ionospheric delays. Accordingly, the communications device 208 extends its measurement window by 2 ms and is thus able to receive the second measurement signals 610 within the extended second measurement window 608.

The duration of the measurement gap may be configured accordingly, i.e. taking into account the transmission time of the measurement signals to be measured, the additional amount and the RF retuning periods.

In some embodiments, the measurement configuration indication 602 comprises an indication of a measurement gap which accommodates not only the RF re-tuning time and the measurement window corresponding to the duration of the sequence of measurement signals to be measured, but includes a further time period to accommodate differences (or changes thereto) in the propagation delays of signals transmitted in the serving cell and the candidate cell as received at the communications device 208.

In some embodiments, the measurement configuration indication 602 comprises an indication of a measurement gap having a total duration equal to one of 6.5 ms, 7 ms, 7.5 ms and 8 ms.

In some embodiments, the measurement configuration indication 602 comprises an enhanced MeasGapConfig information element as shown below:

Proposed MeasGapConfig information element

| | |
|---|---|
| GapConfig ::= | SEQUENCE { |
| gapOffset | INTEGER (0..159), |
| mgl | ENUMERATED {ms1dot5, ms3, ms3dot5, ms4, ms5dot5, ms6, |

ms6dot5, ms7, ms7dot5, ms8 },

| | |
|---|---|
| mgrp | ENUMERATED {ms20, ms40, ms80, ms160}, |
| mgta | ENUMERATED {ms0, ms0dot25, ms0dot5}, |
| . . . , | |
| [[ | |
| refServCellIndicator | ENUMERATED {pCell, pSCell, mcg-FR2} |

OPTIONAL -- Cond NEDCorNRDC
]]

In response to receiving an enhanced MeasGapConfig information element indicating a gap length of greater than 6 ms, the communications device 208 determines an increased measurement window duration based on the indicated gap length, and performs measurements of the measurement signals during the determined measurement window.

In some embodiments of the present technique, the number of SSBs to be measured within a measurement window is reduced to be fewer than those transmitted in a particular sequence within a duration corresponding to the length of the measurement window (i.e. the measurement gap reduced by the length of the RF re-tuning periods).

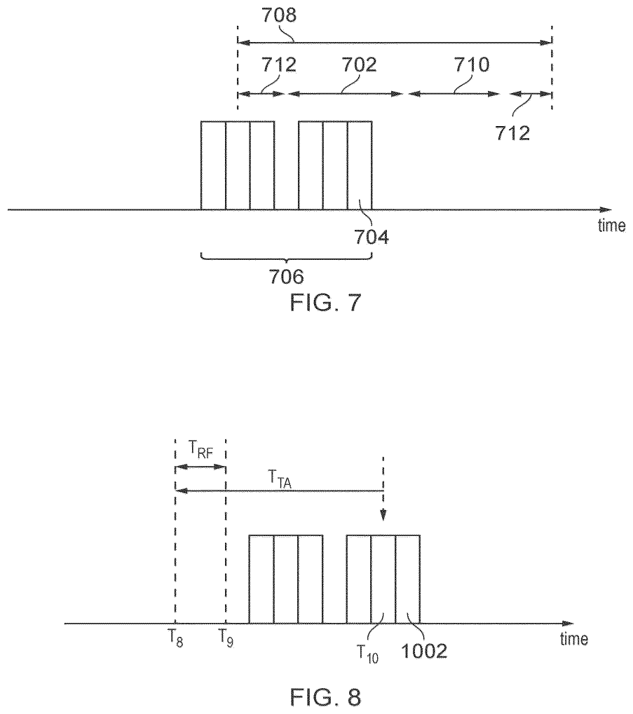

FIG. 7 illustrates a measurement configuration in accordance with some such embodiments of the present technique, in which only a portion of the measurement gap comprises a propagation compensation period in which no SSBs are measured.

In the example illustrated in FIG. 7, an SMTC window duration 702 extends to cover only a subset of the SSBs 704 in a sequence of SSBs 706, while the measurement gap 708 includes a propagation compensation period 710 in addition to RF re-tuning periods 712. For example, the duration of the measurement gap 708 may be determined as:

(2×RF re-tuning delay)+(T_{MEAS-REDUCED})+(T_{PROP})

where T_{PROP} is equal to or greater than a duration for compensating for a change in (or relative difference in) propagation delays between signals in the serving cell and those in the candidate cell, and T_{MEAS-REDUCED} is the duration for which measurements of SSBs are carried out.

In some embodiments, the measurement gap length (and correspondingly, the measurement window duration) is extended to accommodate the change in (or relative difference in) propagation delays, by a base measurement gap length (base MGL) amount signalled separately from an indication of the unextended measurement gap. For example, in some embodiments, a measurement gap length extension indication is transmitted in the serving cell as part of system information. The system information may be broadcast or transmitted in a point-to-point (unicast) manner to the communications device 208. In some embodiments, the MeasGapConfig information element is extended by the addition of an indication of the amount by which the indicated measurement gap length is to be extended.

Accordingly, no change is made to conventional signalling such as the mgl field in the conventional MeasConfigInformation information element.

In accordance with some embodiments, the base MGL is determined based on the location of the communications device 208. In some embodiments, the base MGL is indicated to the communications device 208 in dedicated (i.e. point-to-point) signalling. The base MGL for a given communications device may be updated periodically, or in response to a determination that the base MGL has changed.

In some embodiments, the timing advance defining the duration between the start of the measurement window and the start of the measurement gap is configured so as to compensate for a change in (or relative difference in) propagation delays between signals in the serving cell and those in the candidate cell. The start of the measurement gap is accordingly determined by the communications device 208 based on the modified timing advance; however, the communications device 208 then begins measurements after RF re-tuning without any additional further delay.

For example, the communications device 208 may determine that the indicated timing advance differs from a predetermined value (e.g. 0.5 ms, corresponding to a conventional RF retuning delay) and in response, may set the start of the measurement gap based on the indicated timing advance and the indicated measurement window start time. However, the communications device 208 then carries out the RF re-tuning and initiates measurements irrespective of the indicated timing advance.

In some embodiments, the measurement gap is, in effect, displaced in time based on the indicated timing advance. Accordingly, the communications device 208 determines the start of the measurement gap based on the indicated timing advance, and after the start of the measurement gap, initiates RF retuning followed by measurements of the measurement signals.

FIG. 8 illustrates an example of determining a start time for measurements based on an indicated timing advance in accordance with embodiments of the present technique. In the example of FIG. 8, the indicated measurement window start time is at T10 and the indicated timing advance T_{TA} is 2 ms. The communications device accordingly sets the start of the measurement gap at T8=T10−T_{TA}.

At time T8, the communications device 208 performs RF re-tuning, taking TRF time to do this. After performing the RF re-tuning and without regards to the actual value (other than, in some examples, to determine that the indicated T_{TA} differs from a predetermined timing advance value), the communications device 208 starts the measurement window at T9 and performs measurements of the SSBs 1002 transmitted in the candidate cell. Accordingly, the communications device 208 is able to receive and measure the measurement signals 1002 even though they arrived before (e.g. because of a reducing propagation delay) the start of the indicated measurement window start time.

The same principle can be applied in some examples to compensate for a high (or increasing) propagation delay of the measurement signals, by signalling a timing advance which is less than that required for RF re-tuning, and potentially may be negative (i.e. indicating that the measurement gap starts after the indicated start of the measurement window).

Conventionally, the minimum configurable periodicity of SSB sequence transmissions is 5 ms, and the maximum configurable duration of the measurement window is 5 ms. With such a configuration, it can be ensured, regardless of propagation delays, that the communications device can receive, in any given 5 ms measurement window, at least one SSB. As described above, in some examples, the measurement window duration is increased, such that in scenarios where the SSB sequence transmission periodicity is 5 ms, the number of SSBs received and measured can be increased, irrespective of the time of arrival of the SSBs relative to the measurement window.

However, increasing the measurement gap length reduces the ability of the communications device 208 to receive and transmit data in its serving cell. In some embodiments, in order to overcome this, the rate at which SSBs are transmitted in the candidate cell and/or the duration of measurement windows are set so that irrespective of the actual or relative propagation delays, at least some SSBs can be received in any given measurement window.

In some such embodiments, the duration of a measurement window is set to be a multiple, greater than one, of the periodicity of the SSB sequence transmissions.

In some embodiments, the periodicity of SSB transmissions is set to less than a maximum duration of the measurement window. For example, in some embodiments, the periodicity of SSB sequence transmissions may be set to 2 ms or to 4 ms and the duration of the measurement window may be set to 6 ms.

In some embodiments, additionally or alternatively, the total time allocated for measurements is reduced, for example by either by reducing the duration of each measurement window and measurement gap or by reducing their frequency.

Conventionally, a measurement signal sequence may comprise at most a maximum number of SSB transmissions in a sequence, the maximum number being determined based on, for example, a frequency band in which the transmissions are occurring. Where the number of SSB transmissions in the measurement signals is less than the maximum (e.g. because the cell transmissions are using fewer than the maximum possible number of beams for its frequency band), in accordance with some embodiments of the present technique, a shorter measurement window can be configured for such cells, while the measurement gap length is maintained. By offsetting the measurement gap to start earlier, a shortened measurement window can be located towards the middle of the measurement gap.

Accordingly a length of time during which measurement signals from such cells that arrive outside the configured measurement window can be measured is increased.

Conventionally, the communications device 208 may receive multiple measurement gap indications such as indications for cells in different frequency bands, for cells generated by terrestrial and for cells generated by non-terrestrial network parts.

In some embodiments of the present technique, the communications device uses measurement gaps configured for measuring NTN cells (i.e. those generated by an NTN part of the wireless communications network) for additionally measuring terrestrial network (TN) cells.

For example, in accordance with one or more techniques disclosed above, the measurement window is extended in order to permit the communications device to measure both measurement signals transmitted by NTN parts in NTN cells and measurement signals transmitted by TN parts in TN cells, within the same measurement window.

Thus, the configuration and signalling for the communications device 208 may be reduced, while permitting the communications device 208 to perform measurements of both NTN and TN candidate cells.

In the above description, it has been described how measurement gaps and/or measurement windows may be configured and/or adjusted in order to compensate for propagation delays applicable to transmissions in the serving cell and/or in the candidate cell.

In the following it is described how such measurement configurations may be determined.

In some embodiments, the determination of the measurement gaps and measurement windows is carried out by the communications device 208, based on assistance data received from the wireless communications network.

In other embodiments, the determination of the measurement configuration (i.e. the measurement gaps and measurement windows) is carried out by the wireless communications network, e.g. by the non-terrestrial network part 308 or by its corresponding base station 101.

In general, the measurement configuration determination is carried out based on information identifying or relating to one or more of the following:
a set of candidate cells;
measurement signal transmission schedule for the candidate cells;
non-terrestrial network (NTN) parts (e.g. satellites) associated with (i.e. generating) the set of candidate cells;
orbit information for each NTN part;
a gateway location of a ground station/base station associated with each NTN part;
a location of the communications device 208; and
an ionospheric delay.

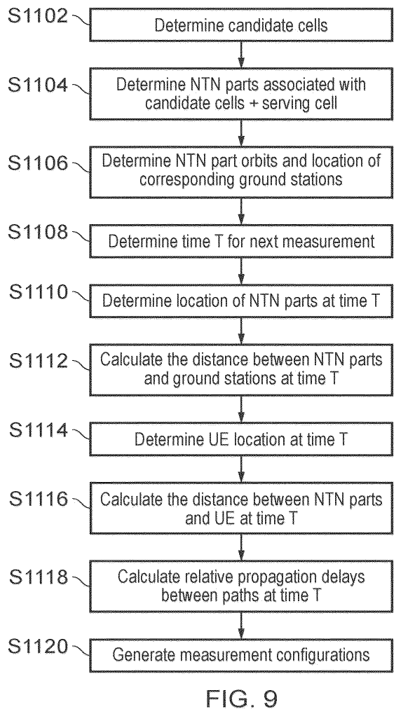

FIG. 9 illustrates a process for determining a measurement configuration in accordance with embodiments of the present disclosure.

The process starts at step S1102 in which the candidate cells are determined. Based on the determined candidate cells, then at step S1104, the corresponding NTN parts which generate the candidate cells are determined.

At step S1106, orbits of the corresponding NTN parts generating the candidate cells are determined, and the location(s) of the ground station(s) associated with the corresponding NTN parts are determined. The corresponding NTN parts may also include the NTN part generating the serving cell.

At step S1108, a time T (which may be approximate) when a next measurement by the communications device 208 is to be carried out is determined. At step S1110, based on the orbits determined at step S1106, the locations of the corresponding NTN parts at time T is determined.

Based on the locations of the corresponding NTN parts determined at step S1110, the distance between each corresponding NTN part and its respective ground station at time T is determined at step S1112.

At step S1114, the location of the communications device 208 at time T is determined. In some embodiments this may be estimated based on a current or past location of the communications device 208. In some embodiments, step S1114 may be carried out by the communications device 208 shortly before time T in order to obtain an accurate estimation of the location of the communications device at time T.

Based on the locations of the corresponding NTN parts determined at step S1110 and the location of the communications device 208 determined at step S1114, then at step S1116, distances between each of the NTN parts and the communications device 208 at time T are determined.

Based on the distances determined at steps S1116 and S1112, the propagation delays applicable to transmissions in the serving cell and each of the candidate cells are determined in step S1118. The propagation delays may be determined taking into account ionospheric delays.

Based on the propagation delays determined in step S1118, and the measurement signal transmission schedule for the candidate cells, measurement parameters defining the measurement configuration (measurement gap, measurement window and the like) are determined. In some embodiments, the time T may be refined based on the measurement signal transmission schedule in a candidate cell and the measurement parameters may be determined based on the refined time T.

In some embodiments, some or all of the steps in the process of FIG. 9 are carried out by the base station 101 and/or the NTN part 308. Following the process of FIG. 9, the determined measurement parameters are indicated to the communications device 208 by means of, for example, an RRC configuration message. In some embodiments, where measurement parameters are determined other than by the communications device 208, adjustments to previous parameters may be signalled by means of RRC signalling, layer 2 (L2, e.g. medium access control) signalling, or layer 1 (L1, e.g. physical layer) signalling.

In general, the process of FIG. 9 ensures that measurement signals transmitted by the candidate cell(s) are received at the communications device 208 within the measurement windows, in accordance with the determined measurement parameters.

In some embodiments, one or more steps (or all) of the process of FIG. 9 is carried out in response to a determination that the candidate cell is provided by an NTN part. In some embodiments, one or more steps (or all) of the process is carried out in response to a determination that the coverage area of one or more of the serving cell and the candidate cell move with respect to the surface of the earth, e.g. are provided by an NTN part which is not geo-stationary.

In some embodiments, one or more of the steps of the process of FIG. 9 is omitted, re-ordered, or modified. For example, in some embodiments, in response to a determination that a candidate cell is provided by an NTN part, the measurement configuration is determined without regards to the locations of the communications device 208. In some embodiments, a fixed measurement configuration is determined which is applicable for any measurement window for measuring measurement signals transmitted in candidate cells which are provided by NTN parts.

In some embodiments, the process described above and illustrated in FIG. 9 may be used to determine one or more of T_{MEAS-REDUCED}, T_{PROP} and T_{WINDOW}, such that the communications device 208 receives measurement signals within the measurement window determined according to the process of FIG. 9.

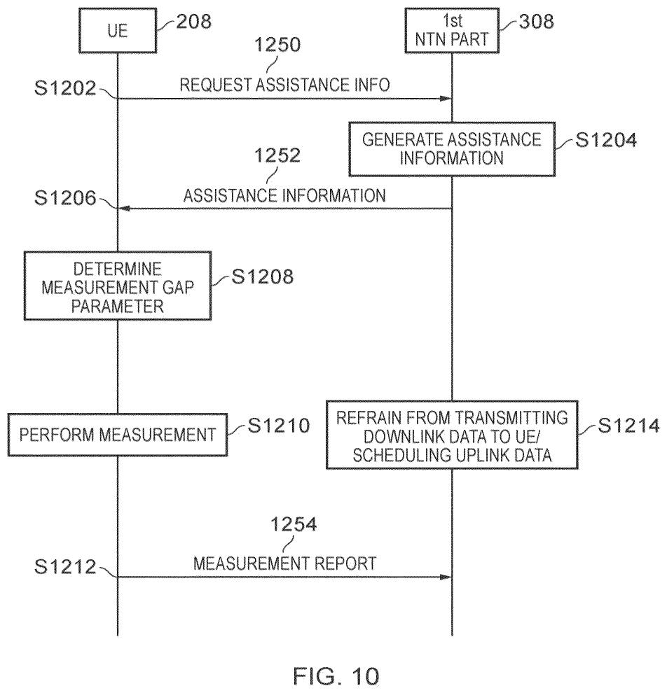

In some embodiments, the steps in the process of FIG. 9 are carried out by the communications device, as illustrated in FIG. 10.

FIG. 10 illustrates a message sequence chart and process flow diagram for a process of performing measurements of candidate cells in accordance with embodiments of the present disclosure.

The process starts at step S1202 in which the communications device 208 transmits a Request assistance information indication 1250 in the serving cell to the first non-terrestrial network part 308.

In response to receiving the Request assistance information indication 1250, at step S1204 the first non-terrestrial network part 308 generates assistance information, such as cell identifiers, NTN part orbit information (which may comprise ephemeris and/or almanac information), NTN ground station identities, NTN ground station locations, and other information required for the carrying out of the process of FIG. 9 as described above. In some embodiments, the assistance information includes a location of the communications device 208, however in some embodiments, this is determined autonomously by the communications device 208.

In some embodiments, validity information is transmitted in addition to, or as part of, the assistance information. The validity information allows the communications device 208 to subsequently determine whether the assistance information is valid for determining information used in the determination of the measurement window. The validity information may comprise one or more of an issue time, a version indication, a validity time and a validity area associated with the assistance information.

At step S1206, the first non-terrestrial network part 308 transmits the assistance information 1252 to the communications device 208.

In some embodiments, the assistance information 1252 and, optionally the validity information, may be transmitted using RRC dedicated (point-to-point, unicast) signalling. In some embodiments, the assistance information 1252 may be transmitted in system information which may be broadcast or transmitted in a unicast manner to the communications device 208.

In some embodiments, the assistance information 1252 and/or the validity information is generated and transmitted at a protocol layer above the RRC layer, for example at an application layer.

In some embodiments, the assistance information 1252 may comprise a plurality of assistance information portions, which may be transmitted in different messages, and/or using different protocol layers. In some embodiments, the validity information may be transmitted using a different message and/or different protocol layer from some or all of the assistance information.

Based on the assistance information 1252, at step S1208 the communications device 208 determines measurement parameters, for example in accordance with the process illustrated in FIG. 9 and described above.

Based on the measurement parameters, at step S1210 the communications device 208 performs measurements of measurement signals transmitted in one or more candidate cells.

At step S1212, the communications device 208 transmits a measurement report 1254 to the first non-terrestrial network part 308, based on the results of the measurements performed at step S1210.

One or more steps of the process shown in FIG. 10 may be repeated. For example, steps S1208 and S1210 may be repeated for each measurement sample obtained, for as long as the assistance information remains valid. If the communications device 208 determines, based on the validity information or otherwise, that the assistance information is no longer valid, it may repeat the process starting at step S1202.

In some embodiments, step S1208 may be performed periodically (e.g. not for every measurement sample) in order to reduce processing requirements at the communications device 208.

In some embodiments, and not shown in FIG. 10, the first non-terrestrial network part 308 may also carry out a step analogous to step S1208 described above in order to determine the measurement parameters used by the communications device 208 in step S1210. As shown in step S1214 in FIG. 14, the first non-terrestrial network part 308 may refrain from scheduling uplink or downlink communications to or from the communications device 208 in the serving cell during measurement gaps based on these measurement parameters. The 308 may carry out step S1208 based on an estimate of the location of the communications device 208.

Embodiments of the present technique can therefore provide measurement windows for measuring measurement signals in candidate cells which permit the communications device 208 to receive and measure the measurement signals taking into account differences or changes over time in propagation delays between the serving cell and the candidate cell. For example, where propagation delays in a serving cell remain constant while propagation delays in a candidate cell are increasing, a future measurement window can be defined to take into account relative variation in the propagation delays.

Embodiments of the present technique can therefore provide a means for dynamic updating of measurement configuration parameters, without requiring repeated signalling between the first non-terrestrial network part 308 and the communications device 208.

By determining appropriate measurement gaps and measurement windows, improved candidate cell measurements can be made in which measurement signals are received and measured within the measurement windows, while the duration of measurement gaps is minimised, thereby avoiding unnecessary restrictions on the scheduling of data transmissions in the serving cell.

In some embodiments, some or all of the steps described as carried out by the first non-terrestrial network part 308 may be carried out by the base station 101. Accordingly, messages described above as being transmitted by, or received by the first non-terrestrial network part 308 may be relayed by the first non-terrestrial network part 308 to or from the base station 101.

Steps in the processes described above may be omitted, re-ordered, or modified. For example, in the process illustrated in FIG. 10, in some embodiments, step S1202 is omitted and the assistance information 1252 is generated and transmitted to the communications device 208 without any request having been received at the wireless network.

In the examples above, the serving cell is an NTN cell generated by an NTN part. However, the scope of the present disclosure is not so limited, and in some embodiments, the serving cell may be generated by one or more terrestrial antennae.

Thus there has been described a method of configuring a communications device in a serving cell of a wireless communications network comprising a non-terrestrial network part, the method comprising: establishing a connection in the serving cell between the communications device and the wireless communications network for transmitting data to and receiving data from the communications device, identifying a candidate cell for a handover of the communications device, determining that one or both of the serving cell and the candidate cell is provided by a non-terrestrial network part of the wireless communications network, based on the determining that one or both of the serving cell and the candidate cell is provided by a non-terrestrial network part of the wireless communications network, determining as a measurement window a time period during which the communications device can receive measurement signals transmitted in the candidate cell, and configuring the communications device to measure the measurement signals received within the measurement window.

There has also been described communications devices, infrastructure equipment and circuitry therefor.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to machine type communication devices/IoT devices or other narrowband communications devices, but can be applied more generally, for example in respect of any type of communications device operating with a wireless link to the communication network.

It will further be appreciated that the principles described herein are not applicable only to LTE-based or 5G/NR-based wireless telecommunications systems, but are applicable for any type of wireless telecommunications system in which a propagation delay of signals transmitted in a cell received by a communications device may change significantly over time and/or differ significantly from a propagation delay of other signals transmitted in a different cell.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of configuring a communications device in a serving cell of a wireless communications network comprising a non-terrestrial network part, the method comprising: establishing a connection in the serving cell between the communications device and the wireless communications network for transmitting data to and receiving data from the communications device, identifying a candidate cell for a handover of the communications device, determining that one or both of the serving cell and the candidate cell is provided by a non-terrestrial network part of the wireless communications network, based on the determining that one or both of the serving cell and the candidate cell is provided by a non-terrestrial network part of the wireless communications network, determining as a measurement window a time period during which the communications device can receive measurement signals transmitted in the candidate cell, and configuring the communications device to measure the measurement signals received within the measurement window.

Paragraph 2. A method according to paragraph 1, wherein the measurement signals are transmitted in the candidate cell in accordance with a measurement signal schedule, the measurement signal schedule defining a predetermined measurement signal sequence duration and a predetermined measurement signal sequence periodicity.

Paragraph 3. A method according to paragraph 2, wherein the duration of the measurement window exceeds the measurement signal sequence duration by an extension time and wherein the method comprises determining the extension time.

Paragraph 4. A method according to paragraph 3, wherein an indication of the extension time is transmitted to the communications device in the serving cell.

Paragraph 5. A method according to paragraph 4, wherein the indication of the extension time is transmitted to the communications device in the serving cell in a broadcast message.

Paragraph 6. A method according to any of paragraphs 2 to 5, wherein the method comprises determining a start offset time defining a time offset between a start of a measurement gap, during which no data is transmitted to or by the communications device in the serving cell, and a start time of the measurement window, wherein configuring the communications device with the measurement window comprises configuring the communications device with the start offset time and the start of the measurement gap.

Paragraph 7. A method according to any of paragraphs 2 to 6, wherein the duration of the measurement window is greater than the measurement signal sequence periodicity.

Paragraph 8. A method according to any of paragraphs 1 to 7, the method comprising: identifying a second candidate cell, the second candidate cell being provided by a terrestrial network part and operating at a different frequency from the candidate cell, and configuring the communications device to measure second measurement signals transmitted in the second candidate cell within the measurement window.

Paragraph 9. A method according to any of paragraphs 1 to 8, wherein the determining the measurement window comprises: determining a difference between a propagation delay of signals transmitted in the candidate cell and received at the communications device at the start time of the measurement window and a propagation delay of signals transmitted in the serving cell and received at the communications device at the start time of the measurement window.

Paragraph 10. A method according to paragraph 9, wherein the serving cell is generated by a first non-terrestrial network part, the method comprising determining a location of the first non-terrestrial network part at the start time of the measurement window, and determining a location of the communications device at the start time of the measurement window.

Paragraph 11. A method according to paragraph 10, the method comprising: determining a location of a ground station associated with the first non-terrestrial network part at the start time of the measurement window.

Paragraph 12. A method according to paragraph 10 or paragraph 11, wherein the candidate cell is generated by a second non-terrestrial network part, the method comprising determining a location of the second non-terrestrial network part at the start time of the measurement window.

Paragraph 13. A method according to paragraph 12, the method comprising: determining a location of a ground station associated with the second non-terrestrial network part at the start time of the measurement window.

Paragraph 14. A method according to any of paragraphs 1 to 13, wherein configuring the communications device to measure the measurement signals received within the measurement window comprises transmitting to the communications device an indication of measurement parameters defining the measurement window, and wherein the method comprises: receiving from the communications device a measurement report, the measurement report comprising an indication of a candidate cell measurement result based on measurements by the communications device of the measurement signals received during the measurement window.

Paragraph 15. A method according to any of paragraphs 1 to 14, the method comprising: receiving from the communications device a request for assistance information, and in response to receiving the request for the assistance information, transmitting the assistance information to the communications device, wherein the assistance information comprises one or more of: cell identifiers, non-terrestrial network (NTN) part orbit information comprising one or more of ephemeris and/or almanac information, NTN ground station identities, NTN ground station locations, and a location of the communications device.

Paragraph 16. A method according to paragraph 15, wherein the method comprises transmitting to the communications device validity information for determining a validity of the assistance information, the validity information comprising one or more of an issue time, a version indication, a validity time and a validity area.

Paragraph 17. A method according to paragraph 15 or paragraph 16, wherein at least a portion of the validity information is transmitted using radio resource control (RRC) unicast signalling.

Paragraph 18. A method according to any of paragraphs 15 to 17, wherein at least a portion of the validity information is transmitted in broadcast system information.

Paragraph 19. A method according to any of paragraphs 15 to 18, wherein at least a portion of the validity information is generated and transmitted at an application layer.

Paragraph 20. A method according to any of paragraphs 1 to 13, wherein the method comprises: measuring the measurement signals received during the measurement window, and transmitting a measurement report, the measurement report comprising an indication of a candidate cell measurement result based on the measuring.

Paragraph 21. A method according to paragraph 20, the method comprising: transmitting to the wireless communications network a request for assistance information, receiving the assistance information transmitted in response to the request for the assistance information, wherein the assistance information comprises one or more of: cell identifiers, non-terrestrial network (NTN) part orbit information comprising one or more of ephemeris and/or almanac information, NTN ground station identities, NTN ground station locations, and a location of the communications device, and wherein the determining the measurement window is based on the assistance information.

Paragraph 22. A method according to paragraph 21, the method comprising determining that stored assistance data is not valid based on validity information associated with the stored assistance data, wherein transmitting to the wireless communications network the request for assistance information is in response to determining that stored assistance data is not valid.

Paragraph 23. Communications apparatus for configuring a communications device in a serving cell of a wireless communications network comprising a non-terrestrial network part providing the serving cell, the communications apparatus comprising: a transceiver for transmitting and receiving signals on a wireless access interface to or from the non-terrestrial network part, and a controller configured to control the transceiver so that the communications apparatus is operable: to establish a connection in the serving cell between the communications device and the wireless communications network for transmitting data to and receiving data from the communications device, to identify a candidate cell for a handover of the communications device, to determine that one or both of the serving cell and the candidate cell is provided by a non-terrestrial network part of the wireless communications network, based on the determining that one or both of the serving cell and the candidate cell is provided by a non-terrestrial network part of the wireless communications network, to determine as a measurement window a time period during which the communications device can receive measurement signals transmitted in the candidate cell, and to configure the communications device to measure the measurement signals received within the measurement window.

Paragraph 24. Infrastructure equipment comprising the communications apparatus according to paragraph 23, wherein the controller is configured to control the transceiver so that the infrastructure equipment is operable: to configure the communications device to measure the measurement signals received within the measurement window by transmitting to the communications device an indication of measurement parameters defining the measurement window, and to receive from the communications device a measurement report, the measurement report comprising an indication of a candidate cell measurement result based on measurements by the communications device of the measurement signals received during the measurement window.

Paragraph 25. A communications device comprising the communications apparatus according to paragraph 23, wherein the controller is configured to control the transceiver so that the communications device is operable: to measure the measurement signals received during the measurement window, and to transmit a measurement report, the measurement report comprising an indication of a candidate cell measurement result based on the measuring.

Paragraph 26. Circuitry for a communications apparatus for configuring a communications device in a serving cell of a wireless communications network comprising a non-terrestrial network part providing the serving cell, the circuitry comprising: transceiver circuitry for transmitting and receiving signals on a wireless access interface to or from the non-terrestrial network part, and controller circuitry configured to control the transceiver so that the communications apparatus is operable: to establish a connection in the serving cell between the communications device and the wireless communications network for transmitting data to and receiving data from the communications device, to identify a candidate cell for a handover of the communications device, to determine that one or both of the serving cell and the candidate cell is provided by a non-terrestrial network part of the wireless communications network, based on the determining that one or both of the serving cell and the candidate cell is provided by a non-terrestrial network part of the wireless communications network, to determine as a measurement window a time period during which the communications device can receive measurement signals transmitted in the candidate cell, and to configure the communications device to measure the measurement signals received within the measurement window.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] 3GPP TR 38.811 V15.1.0 (2019-06) Study on New Radio (NR) to support non terrestrial networks https://www.3gpp.org/ftp/Specs/archive/38_series/38.811/
[2] Holma H. and Toskala A, “LTE for UMTS OFDMA and SC-FDMA based radio access”, John Wiley and Sons, 2009
[3] RP-182090, “Revised SID: Study on NR Industrial Internet of Things (IoT),” RAN #81.
[4] “5G Radio Performance and Radio Resource Management Specifications”, NTT DOCOMO Technical Journal, Vol. 20, No. 3 (January 2019).
[5] 3GPP TR 38.821 V0.7.0 (2019-05) Solutions for NR to support non-terrestrial networks (NTN) https://www.3gpp.org/ftp/Specs/archive/38_series/38.821/
[6] R2-1908755 The Impact by Propagation Delay Difference on Connected Mode CATT

What is claimed is:

1. A User Equipment comprising:
one or more radio transceiver and;
hardware circuitry configured to control the one or more radio transceiver to:
determine a measurement window T_window which is based on a Synchronization Signal (SS)/Physical Broadcast Channel (PBCH) Block (SSB) based measurement timing configuration configured by a first Non-Terrestrial Network part, a periodicity of the SSB based measurement timing configuration being a multiple of the periodicity of SSB sequence transmissions, wherein the SSB sequence transmissions, wherein the measurement window T_window is further extended by an extension indication, and
measure, within the extended measurement window T_window, one or more SSBs transmitted from the first Non-Terrestrial Network part.

2. The UE according to claim 1, wherein the extension indication is based on a broadcast message sent from first Non-Terrestrial Network part.

3. The UE according to claim 1, wherein a minimum configurable periodicity of the periodicity of SSB sequence transmissions is 5 ms.

4. The UE according to claim 1, wherein the periodicity of SSB sequence transmissions is set to less than a maximum duration of the measurement window T_window.

5. A method performed by a User Equipment, the method comprising:
determining a measurement window T_window which is based on a Synchronization Signal (SS)/Physical Broadcast Channel (PBCH) Block (SSB) based measurement timing configuration configured by a first Non-Terrestrial Network part, a periodicity of the SSB based measurement timing configuration being a multiple of the periodicity of SSB sequence transmissions, wherein the SSB sequence transmissions, wherein the measurement window T_window is further extended by an extension indication, and
measuring, within the extended measurement window T_window, one or more SSBs transmitted from the first Non-Terrestrial Network part.

6. The method according to claim 5, wherein the extension indication is based on a broadcast message sent from first Non-Terrestrial Network part.

7. The method according to claim 5, wherein a minimum configurable periodicity of the periodicity of SSB sequence transmissions is 5 ms.

8. The method according to claim 5, wherein the periodicity of SSB sequence transmissions is set to less than a maximum duration of the measurement window T_window.
